(19) United States
(12) Patent Application Publication
(10) Pub. No.: US 2017/0228546 A1
(43) Pub. Date: Aug. 10, 2017

(54) SECURITY SYSTEM AND COMMUNICATION METHOD

(71) Applicant: FUJITSU LIMITED, Kawasaki-shi (JP)

(72) Inventors: Kiyoshi KOHIYAMA, Toshima (JP); Shin HASHIMOTO, Mishima (JP)

(73) Assignee: FUJITSU LIMITED, Kawasaki-shi (JP)

(21) Appl. No.: 15/497,899

(22) Filed: Apr. 26, 2017

Related U.S. Application Data
(63) Continuation of application No. PCT/JP2014/079144, filed on Oct. 31, 2014.

(51) Int. Cl. G06F 21/60; G06F 21/56; G06F 21/50

(52) U.S. Cl. CPC G06F 21/602; G06F 21/50; G06F 21/561

(57) ABSTRACT

A security system includes: a first device that includes a first processor and a first target processor; and a second device that includes a second processor and a second target processor. The first processor executes a first process including: first protecting a first program as a monitoring target among programs operating on the first target processor; first decrypting encrypted data obtained by encrypting output data from the first program; and first encrypting the decrypted output data and causing the encrypted data of the output data to be transmitted to the second device. The second processor executes a second process including: second protecting a second program as a monitoring target among programs operating on the second target processor; second decrypting the transmitted encrypted data of the output data; and second encrypting the decrypted output data and outputting the encrypted data of the output data to the second program.

### CROSS-REFERENCE TO RELATED APPLICATION

This application is a continuation application of International Application No. PCT/JP2014/079144, filed on Oct. 31, 2014 and designating the U.S., the entire contents of which are incorporated herein by reference.

### FIELD

The embodiments discussed herein are related to a security system and a communication method between computer devices.

### BACKGROUND

As Internet devices become widespread, systems using Internet connection or an Internet connection technique have been widely used. One reason for that is that an Internet related technique has been remarkably spread, and the systems can be assembled at low cost by using a mass-produced Internet related technique.

On the other hand, a large number of cases of illegal intrusion and illegal access control are caused, and security systems have been established to cope with such problems. To establish such security systems, the Internet technique is also used in many cases for the above reason.

Typically, to protect a computer device from various computer viruses, antivirus software and the like may be installed in a computer device included in a system. Conventional technologies are described in Japanese Laid-open Patent Publication No. 2008-118265, Japanese Laid-open Patent Publication No. 2009-205627, Japanese Laid-open Patent Publication No. 2012-234362, and Japanese Laid-open Patent Publication No. 2012-38222, for example.

However, the Internet related technique is mass-produced, so that a specification thereof is recognized by a large number of individuals. Thus, there is still a possibility that security of security systems established using such an Internet related technique may be broken even when the antivirus software and the like are installed therein. When the system is established with a plurality of computer devices and some of the computer devices are infected by a virus, an adverse effect may foe spread over various parts of the system.

### SUMMARY

According to an aspect of the embodiments, a security system includes: a first device that includes a first processor and a first target processor; and a second device that includes a second processor and a second target processor. The first processor executes a first process including: first protecting a first program as a monitoring target among programs operating on the first target processor; first decrypting encrypted data obtained by encrypting output data from the first program; and first encrypting the decrypted output data and causing the encrypted data of the output data to be transmitted to the second device. The second processor executes a second process including: second protecting a second program as a monitoring target among programs operating on the second target processor; second decrypting the transmitted encrypted data of the output data; and second encrypting the decrypted output data and outputting the encrypted data of the output data to the second program.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 is a diagram illustrating a configuration example of a monitoring camera system according to a first embodiment;

FIG. 2 is a diagram illustrating an example of communication performed by the monitoring camera system according to the first embodiment;

FIG. 3 is a block diagram illustrating a functional configuration of a computer device included in the monitoring camera system according to the first embodiment;

FIG. 4 is a sequence diagram illustrating a processing procedure of the monitoring camera system according to the first embodiment;

FIG. 5 is a block diagram illustrating a functional configuration of a PC according to an application example;

FIG. 6 is a block diagram illustrating a functional configuration of a PC according to an application example;

FIG. 7 is a diagram illustrating an operation example of an existence confirmation function; and

FIG. 8 is a diagram illustrating an example of multiplexing.

### DESCRIPTION OF EMBODIMENTS

Preferred embodiments will be explained with reference to accompanying drawings. The present invention is not limited to embodiments below. The embodiments can be appropriately combined in a range in which pieces of processing content do not contradict each other.

### [a] First Embodiment

System Configuration

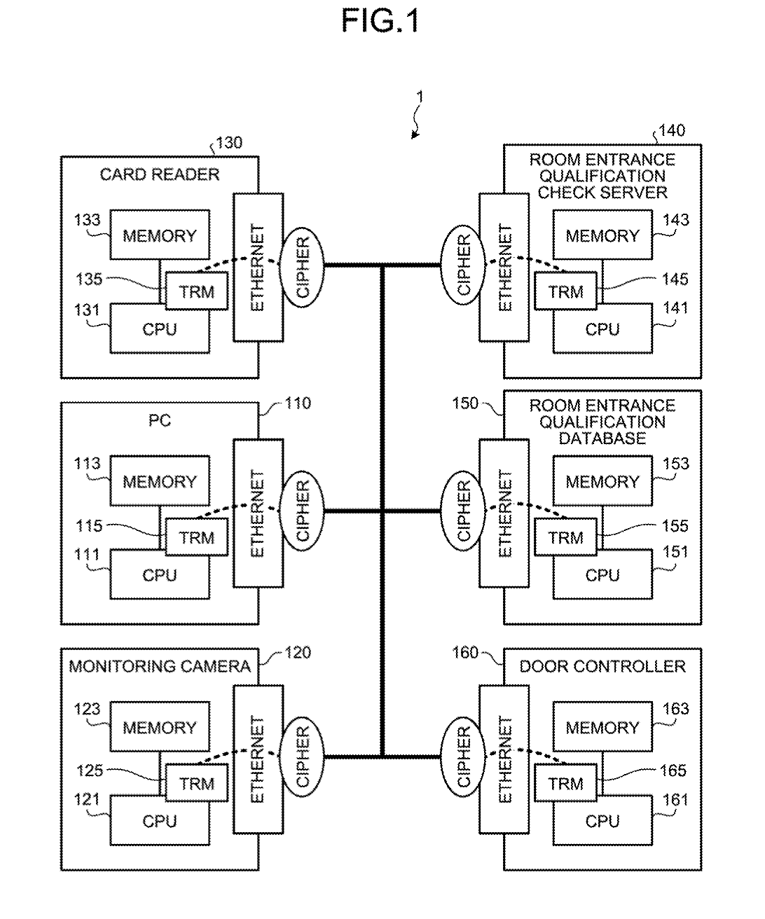

FIG. 1 is a diagram illustrating a configuration example of a monitoring camera system according to a first embodiment. FIG. 1 exemplifies a monitoring camera system 1 as an example of a security system. The monitoring camera system 1 illustrated in FIG. 1 houses computer devices such as a personal computer (PC) 110, a monitoring camera 120, a card reader 130, a room entrance qualification check server 140, a room entrance qualification database 150, and a door controller 160. Hereinafter, the PC 110, the monitoring camera 120, the card reader 130, the room entrance qualification check server 140, the room entrance qualification database 150, and the door controller 160 may be collectively referred to as “computer devices 100”.

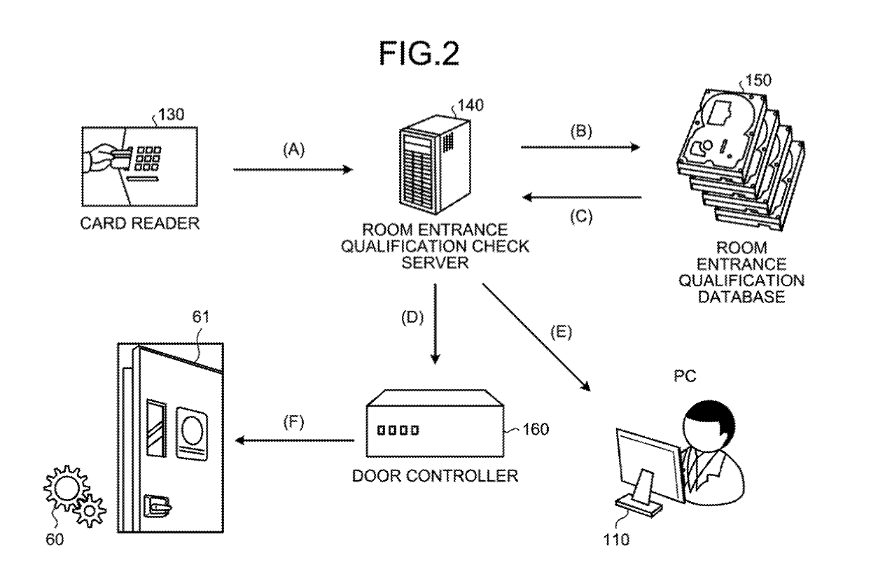

FIG. 2 is a diagram illustrating an example of communication performed by the monitoring camera system according to the first embodiment. For example, when an ID recorded in a card is read by the card reader 130 and a password is input through an input unit such as a numeric keypad added to the card reader 130, as illustrated as (i) in FIG. 2, the ID and the password are transmitted from the card reader 130 to the room entrance qualification check server 140.

Subsequently, as illustrated as (ii) in FIG. 2, the room entrance qualification check server 140 inquires of the room entrance qualification database 150 as to the password corresponding to the ID received from the card reader 130. On the other hand, as illustrated as (iii) in FIG. 2, the room entrance qualification database 150 returns the password corresponding to the ID inquired by the room entrance qualification check server 140 to the room entrance qualification check server 140.

Thereafter, the room entrance qualification check server 140 collates the password received from the card reader 130 with the password returned from the room entrance qualification database 150, and determines whether both passwords match each other.

If both passwords match each other, the room entrance qualification check server 140 instructs the door controller 160 to open a door 61 as illustrated, as (iv) in FIG. 2. Subsequently, as illustrated as (vi) in FIG. 2, the door controller 160 causes a motor 60 to be driven in accordance with the instruction from the room entrance qualification check server 140 to open the door 61. If both passwords do not match each other, the instruction to open the door is not transmitted from the room entrance qualification check server 140 to the door controller 160.

At a timing at which (iv) described above is performed, the room entrance qualification check server 140 transmits a collation result of the password to the PC 110 as illustrated as (v) in FIG. 2. Thereafter, the collation result of the password, for example, “OK” or “NG” is displayed on a display of the PC 110.

Along with (i) to (vi) described above, the PC 110 receives an image of a peripheral part of the door 61 taken by the monitoring camera 120 at a predetermined frame rate, and the image is displayed on the display of the PC 110. Accordingly, when an operation of interrupting opening of the door or of closing the door is received via the input unit of the PC 110, a person in charge of maintenance viewing the display of the PC 110 can determine to cause the PC 110 to instruct the door controller 160 to interrupt opening of the door or instruct to close toe door.

Each of the computer devices 100 included in the monitoring camera system 1 includes a central processing device, what is called central processing units (CPUs) 111, 121, 131, 141, 151, and 161, and a main storage device, what is called memories 113, 123, 133, 143, 153, and 163. The CPU of each computer device executes various pieces of processing by loading various programs read from a read only memory (ROM), an auxiliary storage device (not illustrated), and the like into a memory. A case in which each computer device includes the CPU and the memory is exemplified herein, but some computer devices do not include the CPU and the memory in some cases. The CPU of each computer device is not necessarily implemented as the central processing device, and may be implemented as a micro processing unit (MPU).

A general-purpose operating system (OS) is mounted on the computer device 100, and the computer devices 100 are connected with each other via Ethernet (registered trademark), for example. In this way, the system can be established at low cost by mounting the general-purpose OS on the computer device 100 and implementing communication between the computer devices 100 in the monitoring camera system 1 via Ethernet. The case in which the general-purpose OS is mounted on each computer device 100 is exemplified herein, but a dedicated OS may be mounted in view of improvement in security. The case in which the computer devices 100 are connected to each other via Ethernet is exemplified herein, but some or all of the computer devices 100 may be connected to each other via the Internet.

The internal structure of the computer device 100 including the CPU, the memory, and the OS of a general-purpose type is well-known, so that a possibility of cracking still remains. As an example of a route of cracking, if the monitoring camera system 1 is connected to the Internet, a virus may enter the system via the Internet. The route of cracking is not limited thereto. The virus may enter the system from a universal serial bus (USB) memory and the like.

For example, when the PC 110 for overall control is cracked, the PC 110 is illegally controlled, and a failure may be caused as follows.

1) The “door” controlled by the “door controller 160” is always caused to be in an “opened” state.

2) An image of the “monitoring camera 120” is replaced with a dummy image.

3) An alarm does not ring or the door 61 is opened even when intrusion is detected by the “monitoring camera 120” or the “card reader 130”.

When the monitoring camera 120 is cracked, the dummy image may be input to the PC 110 for overall control. When the door controller 160 is cracked, the door 61 may be kept opened even when the PC 110 for overall control instructs to close the door 61. Additionally, when the card reader 130 is cracked, dummy sensing information, that is, an ID and a password may be input to the room entrance qualification check server 140. Even when another computer device 100 is cracked, a function as the monitoring camera system 1 may be impaired.

In addition to the cracking of the computer device 100, when an Ethernet line is cracked, the function as the monitoring camera system 1 may be impaired due to theft of information or dummy information.

To prevent such cracking, each computer device 100 includes tamper resistant modules (TRMs) 115, 125, 135, 145, 155, and 165 mounted therein having a tamper resistant structure that is hard to peep from the outside or hard to be tampered with.

For example, each TRM has a structure for physically and logically protect against interior analysis or tampering with the TRM, and is implemented as a one-chip large scale integration (LSI) connected to the CPU and the memory of the computer device via a peripheral component interconnect (PCI) bus. Specifically, a firm coating having good adhesion is applied to the inside of each TRM, and an internal circuit is configured to be broken when a surface of the coating is peeled off, or dummy wiring is arranged therein. In this case, the TRM is assumed to be connected to the CPU and the memory of the computer device via the PCI bus. Alternatively, the TRM may be implemented on a system board, or the TRM may be connected via a USB.

Each TRM monitors a program operating on the computer device 100, but does not protect all programs in some cases. That is, each TRM protects only a program as a specific monitoring target among programs such as firmware, middleware, and an application program in addition to the OS operating on the computer device 100. Hereinafter, the program as the monitoring target of the TRM may be referred to as a “monitoring target program”.

Examples of the monitoring target program include a program that serves a function related to the monitoring camera system 1. For example, the PC 110 that performs overall control of the monitoring camera system 1 can protect only a program that remotely controls the computer devices 100 under control of the PC 110, for example, the monitoring camera 120, the card reader 130, the room entrance qualification check server 140, the room entrance qualification database 150, and the door controller 160.

Even when the monitoring target program is protected as described above, the function as the monitoring camera system 1 is not maintained all the time. This is because even when the monitoring target program itself is in a secure state, output data output by the monitoring target program is not secure all the time.

For example, when the OS or the application program operating on the computer device 100, an Ethernet controller, and the like are cracked, output data output by the monitoring target program may be tampered with by malware and the like at the time when the data is output by the monitoring target program. There also remains a possibility that the output data is cracked on a transmission path thereof when the output data is transmitted between the computer devices 100. Additionally, when a program other than the monitoring target program operating on the computer device 100 as a transmission destination is cracked, the output data may be tampered with at the time when the output data is received by the computer device 100 as the transmission destination.

Accordingly, when communication is performed by the computer devices 100, each TRM causes the output data not to be exposed as plain text to the TRM and a program other than the monitoring target program protected by the TRM by encrypting the output data using a method that can be recognized by only a corresponding TRM in advance among a section (A) in which the data is output from the monitoring target program to the transmission path, a section (B) of the transmission path between the computer devices 100, and a section (C) in which the output data received from the transmission path is output to the monitoring target program operating in the computer device 100 as the transmission destination.

Functional Configuration of PC 110

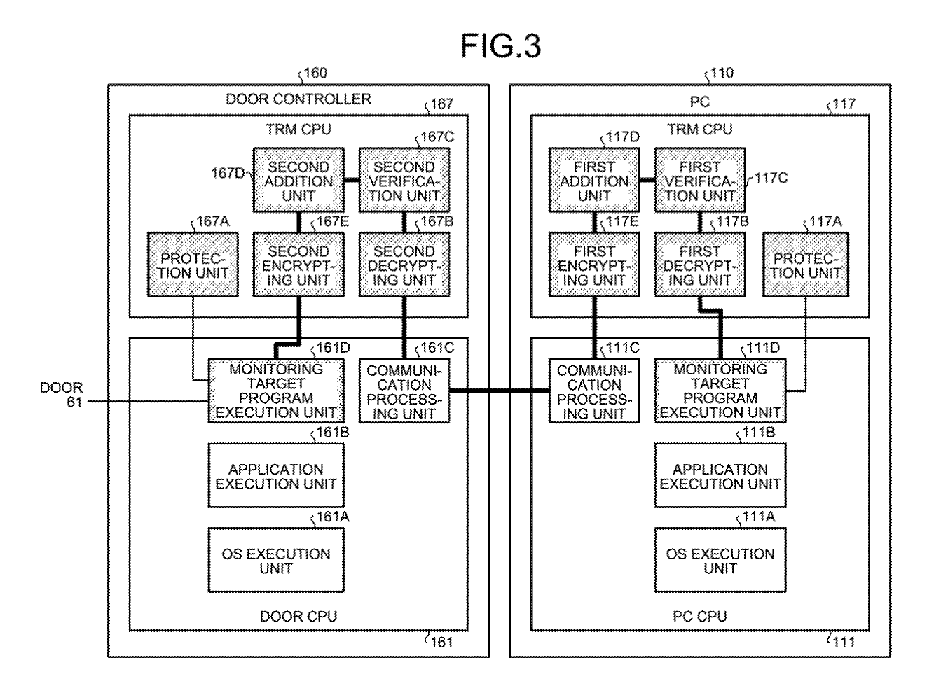

FIG. 3 is a block diagram illustrating a functional configuration of the computer device 100 included in the monitoring camera system 1 according to the first embodiment. FIG. 3 illustrates the PC 110 and the door controller 160 extracted from the computer devices 100 included in the monitoring camera system 1. Each TRM illustrated in FIG. 3 includes minimum functional parts used when the output data from the monitoring target program operating on the CPU 111 of the PC 110 is transmitted to the monitoring target program operating on the CPU 161 of the door controller 160, but the functional configuration is not limited thereto. For example, when a communication direction is reversed, similar communication can be performed by replacing the functional parts included in each TRM between the PC 110 and the door controller 160.

As illustrated in FIG. 3, the PC 110 includes the CPU 111, and includes a CPU 117 of the TRM 115 connected to the CPU 111 via the PCI bus. To distinguish the CPUs from each other, the CPU 111 of the PC 110 may be referred to as a “PC CPU 111”, and the CPU 117 of the TRM 115 may be referred to as a “TRM CPU 117”. In FIG. 3, functional parts other than the PC CPU 111 and the TRM CPU 117 are not illustrated, but a functional part included in an existing computer may be provided. For example, the PC 110 may include a communication interface (I/F) unit implemented by a network interface card, an input device that inputs various instructions, a display device that displays various pieces of information, and the like.

The PC CPU 111 loads various programs read from a read only memory (ROM) or an auxiliary storage device (not illustrated) into a work area on the memory 113 illustrated in FIG. 1 to virtually implement processing units described below. For example, the PC CPU 111 includes an OS execution unit 111A, an application execution unit 111B, a communication processing unit 111C, and a monitoring target program execution unit 111D.

The OS execution unit 111A is a processing unit that controls execution of the OS. The application execution unit 111B is a processing unit that controls execution of the application program. The communication processing unit 111C is a processing unit that controls execution of the Ethernet controller. Software to be executed by these processing units does not correspond to the monitoring target program in the example illustrated in FIG. 3.

The monitoring target program execution unit 111D is a processing unit that controls execution of the monitoring target program.

Examples of the monitoring target program described above include a program that remotely controls at least one computer device 100 among the monitoring camera 120, the card reader 130, the room entrance qualification check server 140, the room entrance qualification database 150, and the door controller 160 under control of the PC 110. In the following description, by way of example, assumed is a case in which the monitoring target program is a program that remotely controls the door controller 160.

The TRM CPU 117 loads a security program read from a ROM or an auxiliary storage device in the TRM 115 (not illustrated) into a work area of a memory in the TRM 115 (not illustrated) to virtually implement processing units described below.

For example, the TRM CPU 117 includes a protection unit 117A, a first decrypting unit 117B, a first verification unit 117C, a first addition unit 117D, and a first encrypting unit 117E. The first decrypting unit 117B, the first addition unit 117D, and the first encrypting unit 117E may be implemented as software, or implemented as hardware such as a circuit.

The protection unit 117A is a processing unit that protects the monitoring target program among programs operating on the PC CPU 111. For example, techniques disclosed in Japanese Laid-open Patent Publication No. 2008-118265,Japanese Laid-open Patent Publication No. 2009-205627,Japanese Laid-open Patent Publication No. 2012-234362, and Japanese Laid-open Patent Publication No. 2012-38222 can be used. Although a case using the technique disclosed in the above documents is exemplified herein, another known technique can be used so long as the technique is used for protecting the program.

As an embodiment, the protection unit 117A has functions of code scan, reconstruction, and a secret number. These functions are present in the TRM 115 that is hard to peep from the outside or tamper with, so that the functions are difficult to be analyzed or tamper with. For example, if the code scan function is analyzed and a code in a part of the monitoring target program to be scanned is found out in advance, a result in which the monitoring target program seems not to be tampered with may be obtained although it is tampered with because a dummy code scan result can be prepared in advance. The reconstruction is a technique for changing or obfuscating a program code inside the monitoring target program although the function is the same seen from the outside, this makes program analysis by a cracker difficult. If the reconstruction function is analyzed, a method of reconstruction may be found out and analyzed by the cracker in advance. The secret number described above is a method in which the protection unit 117A embeds a secret number communication routine in the monitoring target program in advance, performs “secret number communication” while the program is actually operating, and performs authentication between the monitoring target program and the protection unit 117A. For example, a certain number is output from the protection unit 117A to the monitoring target program, and the monitoring target program responses thereto. The protection unit 117A determines correctness of the monitoring target program depending on whether the response is a normal response. The protection unit 117A embeds a different secret number routine in the monitoring target program each time the monitoring target program is initialized, so that the routine is hard to crack by the cracker. However, the routine may be cracked if the inside of the TRM 115 can be peeped and the secret number routine analyzed in advance. Accordingly, cracking the monitoring target program can be made difficult by embedding the functions of code scan, reconstruction, secret number, and the like in the TRM 115 to prevent the functions from being peeped from the outside. By causing the TRM 115 to have a tamper resistant structure, it is difficult to perform tampering, and the code scan function, the reconstruction function, and the secret number communication function can be prevented from being invalidated.

In the monitoring target program protected as described above, analysis of the program code as a precondition of cracking is hard to perform due to the reconstruction function, and even when the program code is analyzed and tampered with, the tampering is detected with the code scan function. The monitoring target program can be authenticated due to the secret number communication function.

The protection unit 117A can embed the “number communication routine” in the monitoring target program, and can also embed a “secret key different for each time”. By using this key, data can be exchanged between the monitoring target program and the TRM 115 without being peeped from another program. Such a function can be used for receiving encrypted output data from the monitoring target program, decrypting the output data, and checking whether the output data is tampered with. When the monitoring target program adds tampering detection information, for example, a hash value of the output data to the output data output from the monitoring target program and encrypts the data with a “secret key different for each time” to be transmitted to the TRM 115, other unprotected programs will find it difficult to peep or tamper with the output data from the monitoring target program. This function can also be used for transmitting data from the TRM 115 to the protected monitoring target program in a form not to be peeped or tampered with by the other programs. In this way, by using the number communication routine described above, the key can be shared between the protection unit 117A and the monitoring target program.

The first decrypting unit 117B is a processing unit that decrypts encrypted data of the output data output by the monitoring target program.

When the output data is transmitted from the PC 110 to the other computer device 100, communication of the output data of the monitoring target program is started between the computer devices 100. For example, described is a case in which the monitoring target program operating on the PC 110 instructs the monitoring target program operating on the door controller 160 to open or close the door 61. In this case, as merely an example, exemplified is the case in which the monitoring target program operating on the PC 110 instructs the monitoring target program operating on the door controller 160 to open or close the door 61, but the embodiment is not limited thereto. That is, similar communication is naturally performed between the computer devices 100 in various scenes including (i) to (vi) and the like described above with reference to FIG. 2.

When a trigger for such communication is generated, the monitoring target program adds tampering verification information, for example, a hash value of the output data as the tampering verification information to the output data output by the monitoring target program, and encrypts the output data and the tampering verification information. In this case, to encrypt the output data, the key exchanged between the monitoring target program and the first decrypting unit 117B in accordance with the number communication routine can be used, for example. As an example of encryption method. Advanced Encryption Standard (AES) encryption, New European Schemes for Signature, Integrity, and Encryption (NESSIE) encryption, and the like can be used. Thereafter, the encrypted data of the output data is output from the monitoring target program execution unit 111D to the first decrypting unit 117B. When receiving the encrypted data of the output data from the monitoring target program operating on the PC CPU 111 as described above, the first decrypting unit 117B decrypts the encrypted data of the output data, and outputs the output data and the tampering verification information to the first verification unit 117C.

The first verification unit 117C is a processing unit that verifies whether the output data is tampered with using the tampering verification information decrypted from the encrypted data of the output data.

As an embodiment, the first verification unit 117C compares the tampering verification information decrypted by the first decrypting unit 117B with the hash value of the output data calculated using a hash function from the output data decrypted by the first decrypting unit 117B. At this point, when the tampering verification information matches the hash value of the output data, it can be estimated that the output data from the monitoring target program is not tampered with by the other program operating on the PC CPU 111. In this case, the first verification unit 117C outputs the output data from the monitoring target program to the first addition unit 117D. When tampering with the output data is detected, the output to the first addition unit 117D can be stopped, or notification can be made via a display device (not illustrated).

The first addition unit 117D is a processing unit that adds the tampering verification information of the output data to the output data decrypted by the first decrypting unit 117B.

As an embodiment, when the first verification unit 117C verifies that the output data is not tampered with, the first addition unit 1170 calculates the hash value of the output data decrypted by the first decrypting unit 117B using a hash function. A digest of the output data is thus generated. This is assumed to be an electronic signature, and the first addition unit 117D adds the electronic signature as the tampering verification information to the output data decrypted by the first decrypting unit 117B.

The first encrypting unit 117E is a processing unit that encrypts the output data to which the tampering verification information is added by the first addition unit 117D.

As an embodiment, the first encrypting unit 117E encrypts the output data to which the tampering verification information is added by the first addition unit 117D using the key exchanged between itself and the TRM on the computer device 100 as the transmission destination of the output data in accordance with a routine similar to the number communication routine described above. As such encryption, for example, AES encryption or NESSIE encryption can be applied similarly to the monitoring target program described above. Thereafter, the first encrypting unit 117E outputs the encrypted data of the output data to the communication processing unit 111C on the PC CPU 111.

The communication processing unit 111C that has received the encrypted data of the output data divides the encrypted data of the output data received from the first encrypting unit 117E to be converted into an Ethernet format, and transmits the encrypted data to Ethernet.

Through a series of processes of the monitoring target program execution unit 111D, the first decrypting unit 117B, the first verification unit 117C, the first addition unit 117D, and the first encrypting unit 117E, the output data can be prevented from being tampered with in the section (A) described above, that is, the section in which the data is output from the monitoring target program to the transmission path.

Although there remains a possibility that the communication processing unit 111C is cracked, the data treated by the communication processing unit 111C is encrypted and has the electronic signature, so that significant tampering with the data is not possible. Additionally, although the output data may be tampered with on the Ethernet line, the data is encrypted and has the electronic signature, so that significant tampering is hardly performed thereon. Accordingly, significant tampering can be prevented from being performed also in the section (B) described above, that is, the section of the transmission path between the computer devices 100.

Functional Configuration of Door Controller 160

As illustrated in FIG. 3, the door controller 160 includes the CPU 161, and includes a CPU 167 of the TRM 165 connected to the CPU 161 via the PCI bus. To distinguish the CPUs from each other, the CPU 161 of the door controller 160 may be referred to as a “door CPU 161”, and the CPU 167 of the TRM 165 may be referred to as a “TRM CPU 167”. In FIG. 3, functional parts other than the door CPU 161 and the TRM CPU 167 are not illustrated, but a functional part included in an existing computer may be provided. For example, the door controller 160 may include a driving unit such as the motor 60 illustrated in FIG. 2 or an input device such as a DIP switch.

The door CPU 161 loads various programs read from a ROM or an auxiliary storage device (not illustrated) into a work area on the memory 163 illustrated in FIG. 1 to virtually implement processing units described below. For example, the door CPU 161 includes an OS execution unit 161A, an application execution unit 161B, a communication processing unit 161C, and a monitoring target program execution unit 161D.

The OS execution unit 161A is a processing unit that controls execution of the OS. The application execution unit 161B is a processing unit that controls execution of the application program. The communication processing unit 161C is a processing unit that controls execution of the Ethernet controller. Software to be executed by these processing units does not correspond to the monitoring target program in the example illustrated in FIG. 3.

The monitoring target program execution unit 161D is a processing unit that controls execution of the monitoring target program. Examples of the monitoring target program include a program that controls opening and closing of the door 61 under control of the door CPU 161. In the following description, by way of example, assumed is a case in which the monitoring target program is a program that controls opening or closing of the door 61.

The TRM CPU 167 loads the security program read from a ROM or an auxiliary storage device in the TRM 165 (not illustrated) into a work area of a memory in the TRM 165 (not illustrated) to virtually implement processing units described below.

For example, the TRM CPU 167 includes a protection unit 167A, a second decrypting unit 167B, a second verification unit 167C, a second addition unit 167D, and a second encrypting unit 167E. The second decrypting unit 167B, the second addition unit 167B, and the second encrypting unit 167E may be implemented as software, or implemented as hardware such as a circuit.

The protection unit 167A is a processing unit that protects the monitoring target program among the programs operating on the door CPU 161. A method for protecting the monitoring target program is the same as that of the protection unit 117A described above, so that redundant description thereof will not be repeated.

The second decrypting unit 167B is a processing unit that decrypts the encrypted data of the output data received by the communication processing unit 161C.

As an embodiment, the second decrypting unit 167B exchanges, with the computer device 100 as a transmission source of the output data such as the TRM 115 on the PC 110, key information for decrypting the encrypted data through mutual communication based on a public key such as a public key infrastructure (PKI), a secret key algorithm, and the like in accordance with the same routine as the number communication routine described above, decrypts the encrypted data of the output data received by the communication processing unit 161C using the public key and the like exchanged as described above, and outputs the output data and the tampering verification information to the second verification unit 167C.

The second verification unit 167C is a processing unit that verifies whether the output data is tampered with using the tampering verification information decrypted from the encrypted data of the output data by the second decrypting unit 167B.

As an embodiment, the second verification unit 167C compares the tampering verification information decrypted by the second decrypting unit 167B with the hash value of the output data calculated using the hash function from the output data decrypted by the second decrypting unit 167B. At this point, when the tampering verification information matches the hash value of the output data, it can be estimated that the output data from the monitoring target program is not tampered with by the other program operating on Ethernet and on the door CPU 161. In this case, the second verification unit 167C outputs the output data from the monitoring target program to the second addition unit 167D. When tampering with the output data is detected, the output to the second addition unit 167D can be stopped, or notification can be made via a display device (not illustrated).

The second addition unit 167D is a processing unit that adds the tampering verification information of the output data to the output data decrypted by the second decrypting unit 167B.

As an embodiment, when the second verification unit 167C verifies that the output data is not tampered with, the second addition unit 167D calculates the hash value of the output data decrypted by the second decrypting unit 167B using a hash function. A digest of the output data is thus generated. This is assumed to be an electronic signature, and the second addition unit 167D adds the electronic signature as the tampering verification information to the output data decrypted by the second decrypting unit 167B.

The second encrypting unit 167E is a processing unit that encrypts the output data to which the tampering verification information is added by the second addition unit 167D.

As an embodiment, the second encrypting unit 167E encrypts the output data to which the tampering verification information is added by the second addition unit 167D using the key exchanged between itself and the monitoring target program executed by the monitoring target program execution unit 161D in accordance with the same routine as the number communication routine described above. To such encryption, for example, an optional algorithm such as AES encryption and NESSIE encryption can be applied. Thereafter, the second encrypting unit 167E outputs the encrypted data of the output data to the monitoring target program operating on the door CPU 161.

In this way, when the output data is output from the second encrypting unit 167E to the monitoring target program, the output data is decrypted by the monitoring target program, and tampering verification is performed on the electronic signature. When it is verified that the output data is not tampered with, the monitoring target program of the door controller 160 executes processing corresponding to the output data from the monitoring target program of the computer device 100 as the transmission source. In this case, the door 61 is opened or closed by the monitoring target program of the door controller 160 in accordance with the instruction to open or close the door from the monitoring target program of the PC 110.

Through a series of processes of the second decrypting unit 167B, the second verification unit 167C, the second addition unit 167D, the second encrypting unit 167E, and the monitoring target program execution unit 161D, the output data can be prevented from being tampered with in the section (C) described above, that is, the section in which the output data received from the transmission path is output to the monitoring target program operating in the computer device 100 as the transmission destination. That is, significant tampering with the output data is prevented from being performed across the sections (A) to (C), so that the monitoring target program is protected, and even when the program other than the monitoring target program such as an OS or an application program is cracked, an adverse effect thereof can be prevented from being spread over various parts of the system.

As described above, significant tampering with the corresponding information is not possible in the monitoring camera system 1, but insignificant tampering can be performed. To securely detect insignificant tampering, for example, a timer is arranged in each of the TRMs of the PC 110 and the door controller 160, and when normal communication (such as mutual communication based on a public key such as a PKI in the TRM, a secret key algorithm, and the like) is not found within a certain period of time, processing of warning a system administrator of a possibility of insignificant tampering can be optionally performed to further enhance security.

Processing Procedure

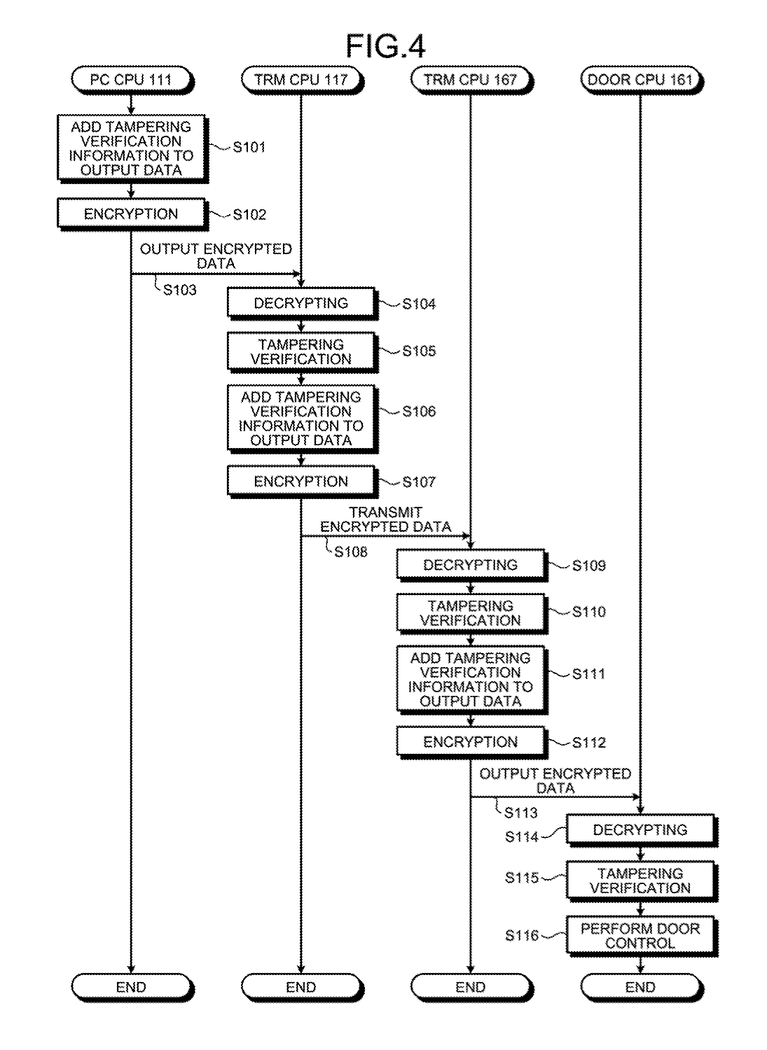

FIG. 4 is a sequence diagram illustrating a processing procedure of the monitoring camera system 1 according to the first embodiment. By way of example, FIG. 4 illustrates a sequence in a case in which the data output by the monitoring target program operating on the PC 110 is transmitted to the monitoring target program operating on the door controller 160. This processing is started in a case in which the output data is transmitted from the PC 110 to the door controller 160.

As illustrated in FIG. 4, the monitoring target program operating on the PC CPU 111 adds the hash value of the output data as the tampering verification information to the output data output by the monitoring target program (Step S101). Subsequently, the monitoring target program operating on the PC CPU 111 encrypts the output data to which the tampering verification information is added at Step S101 (Step S102).

Thereafter, the monitoring target program operating on the PC CPU 111 outputs the encrypted data of the output data encrypted at Step S102 to the first decrypting unit 117B (Step S103).

The first decrypting unit 117B then decrypts the encrypted data of the output data output by the monitoring target program at Step S103 (Step S104), and outputs the output data and the tampering verification information to the first verification unit 117C.

The first verification unit 117C verifies whether the output data decrypted at Step S104 is tampered with using the tampering verification information decrypted from the encrypted data of the output data at Step S104 (Step S105).

After it is verified that the output data is not tampered with through such tampering verification, the first addition unit 117D adds the tampering verification information of the output data again to the output data decrypted at Step S104 (Step S106).

The first encrypting unit 117E encrypts the output data to which the tampering verification information is added at Step S106 (Step S107), and outputs the encrypted data of the output data to the communication processing unit 111C on the PC CPU 111.

Subsequently, the communication processing unit 111C of the PC CPU 111 divides the encrypted data of the output data encrypted at Step S107 to be converted into an Ethernet format, and transmits the encrypted data to Ethernet to transmit the encrypted data of the output data to the door controller 160 (Step S108).

On the other hand, the second decrypting unit 167B of the TRM CPU 167 decrypts the encrypted data of the output data received by the communication processing unit 161C through the transmission at Step S108 (Step S109). Subsequently, the second verification unit 167C verifies whether the output data decrypted at Step S109 is tampered with using the tampering verification information decrypted from the encrypted data of the output data at Step S109 (Step S110).

After it is verified that the output data is not tampered with through such tampering verification, the second addition unit 167D adds the tampering verification information of the output data again to the output data decrypted at Step S109 (Step S111).

The second encrypting unit 167E then encrypts the output data to which the tampering verification information is added at Step S111 (Step S112), and outputs the encrypted data of the output data to the monitoring target program operating on the door CPU 161 (Step S113).

Thereafter, the monitoring target program operating on the door CPU 161 decrypts the encrypted data of the output data received from the second encrypting unit 167E (Step S114), and verifies whether the output data obtained through the decrypting at Step S114 is tampered with using the tampering verification information (Step S115). When it is verified that the output data is not tampered with, the monitoring target program operating on the door CPU 161 performs processing corresponding to the output data from the monitoring target program of the computer device 100 as the transmission source, for example, opening/closing control of the door 61 (Step S116), and ends the processing.

Aspect of Effect

As described above, to perform communication between monitoring target programs operating on different computer devices 100, the monitoring camera system 1 according to the present embodiment protects the monitoring target program, and encrypts the section in which the data is output from the monitoring target program as the transmission source to the transmission path and the section in which the output data received from the transmission path is output to the monitoring target program as the transmission destination. Accordingly, significant tampering with the output data can be prevented from being performed across the sections (A) to (C) in the monitoring camera system 1 according to the present embodiment. Thus, the monitoring camera system 1 according to the present embodiment can prevent the monitoring target program from being cracked, and prevent an adverse effect caused by cracking from being spread over various parts of the system.

### [b] Second Embodiment

The embodiment of the disclosed device has been described above, but the present invention can be implemented in various different forms other than the embodiment described above. The following describes another embodiment of the present invention.

Transmission and Reception of Output Data

In the first embodiment, the minimum functional parts used when the output data from the monitoring target program operating on the PC CPU 111 is transmitted to the monitoring target program operating on the door CPU 161 are exemplified as the functional parts of the PC 110 and the door controller 160, but the embodiment is not limited thereto. For example, the TRM CPU 117 can not only transmit the output data from the monitoring target program operating on the CPU 111 but also receive the output data from the monitoring target program transmitted from the other computer device 100.

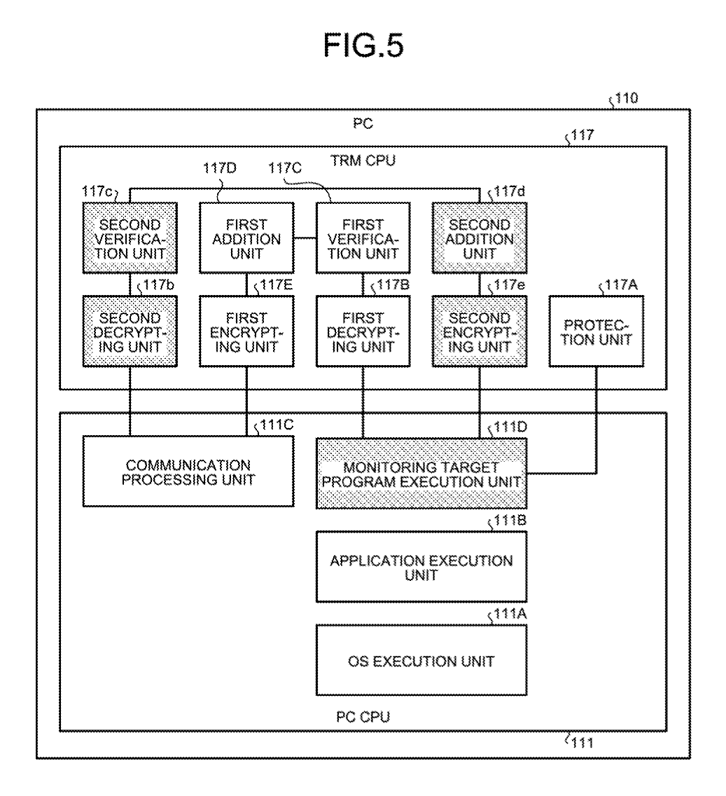

FIG. 5 is a block diagram illustrating a functional configuration of the PC according to an application example. In the following description, a functional part that serves the same function as that illustrated in FIG. 3 is denoted by the same reference numeral as that in FIG. 3, and redundant description thereof will not be repeated. For example, to receive the output data from the monitoring target program transmitted from the other computer device 100, as illustrated in FIG. 5, the TRM CPU 117 includes a second decrypting unit 117b, a second verification unit 117c, a second addition unit 117d, and a second encrypting unit 117e serving the same functions as those of the second decrypting unit 167B, the second verification unit 167C, the second addition unit 167D, and the second encrypting unit 167E of the door controller 160 illustrated in FIG. 3, respectively, and can receive the output data from the monitoring target program transmitted from the other computer device 100.

Direct Connection to TRM

Each computer device 100 does not necessarily input/output data through a device connected to the CPU included in the computer device 100. For example, a warning signal itself to the system administrator and the like may be cracked, so that notification can be made through a display device directly connected to the TRM of each computer device 100, for example, a light emitting diode (LED) lamp.

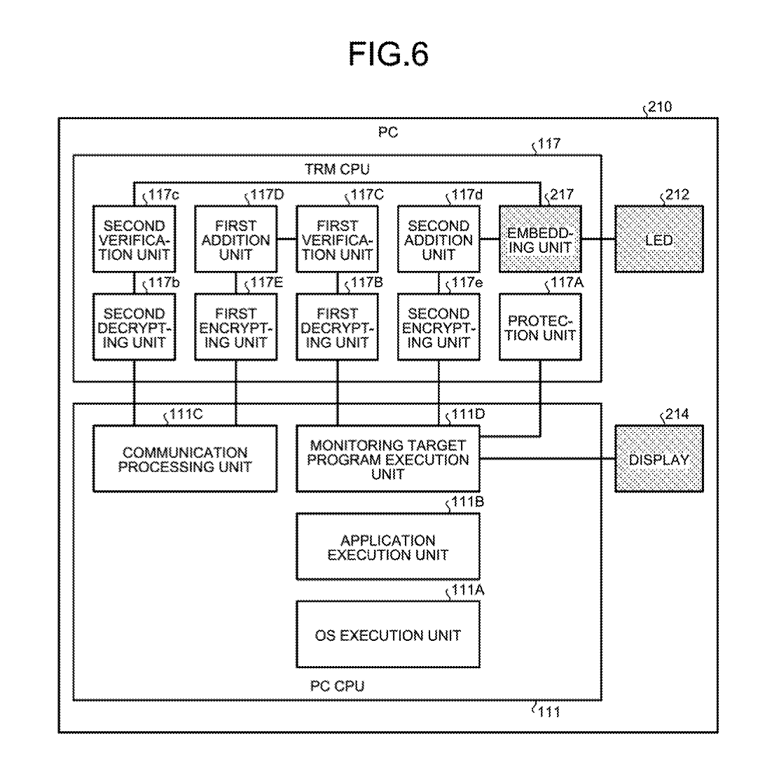

FIG. 6 is a block diagram illustrating a functional configuration of a PC 210 according to the application example. As illustrated in FIG. 6, an LED 212 directly connected to the TRM 115 is arranged in the PC 210. In this way, accuracy in making notification such as a warning signal can be improved by controlling lighting or blinking of the directly connected LED 212 that can be directly controlled by the TRM 115 without being controlled by the PC CPU 111. In the example of FIG. 6, one LED is connected to the TRM 115. Alternatively, a plurality of LEDs can be connected to the TRM 115, For example, a first LED emitting blue light and a second LED emitting red light may be connected to the TRM 115, and the first LED may be turned on and the second LED may be turned off when each computer device 100 is not cracked. When each computer device 100 is cracked, the first LED may be turned off and the second LED may be turned on or caused to blink to generate warning. Three or more LEDs of red, blue, green, and the like may be provided to give warning to the system administrator and the like by classifying blue as a normal state, red as a periodic communication abnormal state, and green as a state in which the monitoring target program may be cracked.

Content Output

For example, the TRM 115 determines whether the output data received from the monitoring target program operating on the other computer device 100 is a control command or content. If the output data is content, predetermined data can be embedded in the content.

By way of example, assumed is a case in which an image taken by the monitoring camera 120 is displayed on the display 214 illustrated in FIG. 6 as an example of the content. In this case, an embedding unit 217 illustrated in FIG. 6 randomly detects a region in which a mark is embedded, for example, a region such as a margin or an end from the image each time the second verification unit 117c detects that the decrypted image is not tampered with, and embeds a predetermined mark such as a figure like a red circle, a character string, and the like in the randomly detected region. At this point, the embedding unit 217 embeds the mark in the image by causing frequency of embedding of the mark in the image to be random between frames of the image. For example, the embedding unit 217 repeats processing of embedding the mark in the image in a predetermined section, for example, during a period corresponding to a random number each time the random number is generated using software or a random number generator that generates random numbers of 0 to 3 including decimals, and interrupting the embedding of the mark in the image during a period corresponding to a random number that is subsequently generated. Along therewith, the embedding unit 217 turns on the LED 212 in synchronization with a timing at which the mark is embedded in the image.

Accordingly, by checking whether the light emitted from the LED 212 is synchronized with the mark displayed on the display 214, a viewer can check whether the image displayed on the display 214 is the image decrypted by the TRM CPU 117. Additionally, display intervals are random and display places are random, so that it can be difficult to analyze data immediately before being displayed and embed the mark in another image to be displayed in real time.

Exemplified herein is a case in which the TRM CPU 117 of the PC 210 embeds the mark. Alternatively, the CPU of the TRM 125 of the monitoring camera 120 may embed the mark. In this case, by adding presence/absence of the mark to met a information of the image, the TRM CPU 117 of the PC 210 can turn on the LED 212 in synchronization with the mark.

Existence Confirmation Function

By implementing, in firmware and the like of each TRM, software for the TRMs that authenticate each other through encryption communication, existence confirmation can be performed between the TRMs of the computer devices 100.

The following describes a procedure of the existence confirmation. The TRM of each computer device 100 generates a public key of a public cipher key system for mutual authentication. For example, N TRMs, that is, a TRM T₁ to a TRM T_{N} are assumed to be present, a management terminal used by the system administrator collects a public key P₁ generated by the TRM T₁, a public key P₂ generated by the TRM T₂, . . . , and a public key P_{N} generated by the TRM T_{N}. Any of the TRM 115 of the PC 110 illustrated in FIG. 1, the TRM 125 of the monitoring camera 120, the TRM 135 of the card reader 130, the TRM 145 of the room entrance qualification check server 140, the TRM 155 of the room entrance qualification database 150, and the TRM 165 of the door controller 160 corresponds to the TRM Tᵢ.

Subsequently, the management terminal distributes, to each TRM Tᵢ, a group of N public keys (P₁, P₂, . . . , and P_{N}) of N TRMs to perform mutual authentication. Thereafter, each TRM Tᵢ returns, to the management terminal, data C₁, C₂, . . . , C_{N} obtained by encrypting, using an individual public key, a hash value obtained based on the public key corresponding to the TRM Tᵢ in the group of N public keys (P₁, P₂, . . . , and P_{N}) of N TRMs and data including a number G for identifying a mutual authentication group of each of the TRM T₁ to T_{N}.

Thereafter, the management terminal sends each piece of C₁ to Tᵢ, and collects an address of the computer device 100 in which each Tᵢ is incorporated, for example, an IP address from each Tᵢ to be sent to each Tᵢ. Each TRM Tᵢ decrypts the data with a secret key pᵢ corresponding to the public key Pᵢ, and holds the data in an internal memory of each TRM Tᵢ. Subsequently, each TRM Tᵢ causes the CPU of each computer device 100 to start a communication process Mᵢ for mutual authentication.

Under the procedure as described above, the communication process Mᵢ for mutual authentication started by the TRM Tᵢ performs IP communication with a communication process Mᵢ₊₁ for mutual authentication among other communication processes for mutual authentication. A communication process M_{N} for mutual authentication transmits a message to a communication process M₁ for mutual authentication.

Thereafter, the communication process Mᵢ for mutual authentication calls TRM Tᵢ every predetermined time, and receives a message for sending. At this point, each TRM Tᵢ passes the message for sending obtained by adding a hash to a correspondence including the group identification number G held by the internal memory of the TRM Tᵢ and time t at this point, and encrypting the correspondence with a public key Pᵢ₊₁ of a TRM Tᵢ₊₁. In this case, when it is detected that any of the monitoring target programs of the TRM Tᵢ is tampered with or the operation thereof is stopped, a message notifying that problem occurs is passed.

On the other hand, the communication process Mᵢ₊₁ for mutual authentication decrypts the message received from the communication process Mᵢ for mutual authentication with a secret key pᵢ₊₁ of itself, and verifies that content is not tampered with. When the content is incorrect or the message does not arrive from the communication process Mᵢ for mutual authentication within a certain period of time, the LED 212 is turned on to generate warning.

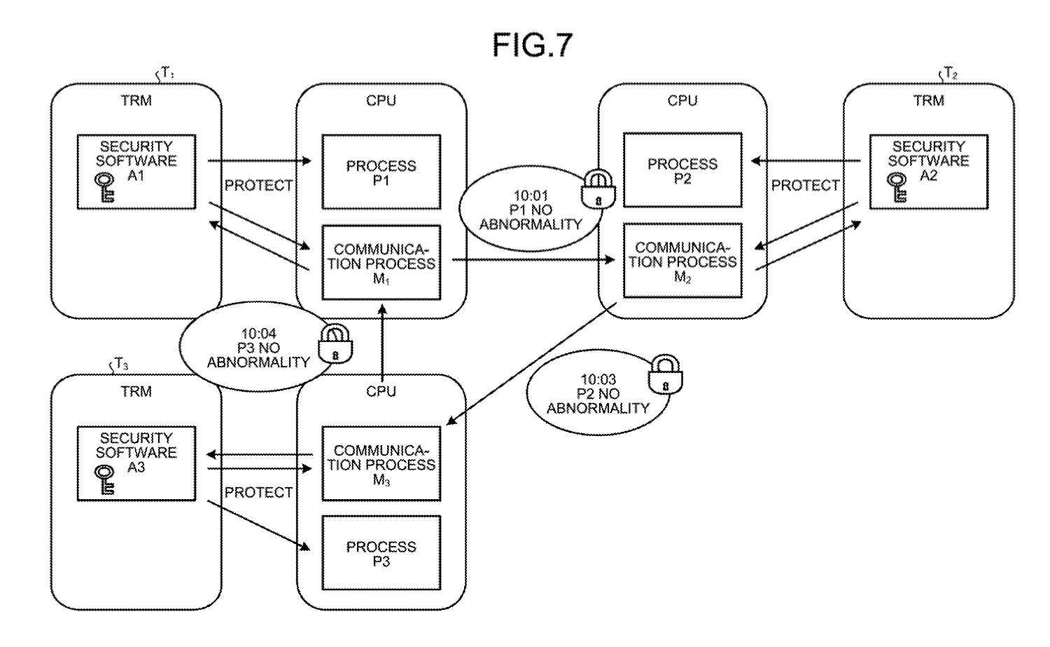

FIG. 7 is a diagram illustrating an operation example of an existence confirmation function. FIG. 7 illustrates a process loaded in the memory of the computer device and the memory of the TRM in a case in which existence confirmation is performed among three TRMs, that is, TRM T₁ to TRM T₃. As illustrated in FIG. 7, in each of the TRM T₁ to the TRM T₃, the public key of the other TRM, the group identification number, and the like are stored in the internal memory of the TRM, and concealed from the communication processes M₁ to M₃ for mutual authentication operated in the CPU on the computer device 100 side. Accordingly, the message transmitted from the communication process M₁ for mutual authentication to the communication process Mᵢ₊₁ for mutual authentication can be prevented from being forged.

Multiplexing of System

In the first embodiment, one computer device is provided for each function. Alternatively, in the monitoring camera system 1, a plurality of computer devices may be arranged for each function to be multiplexed.

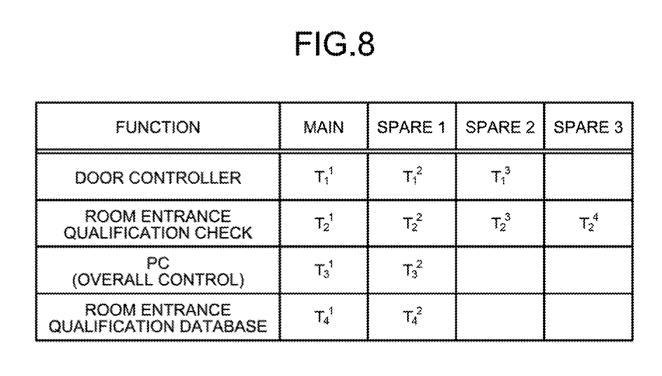

FIG. 8 is a diagram illustrating an example of multiplexing. FIG. 8 illustrates a deployment example of the monitoring camera system 1 in a case in which the door controller 160 is triplicated, the room entrance qualification check server 140 is quadruplicated, the PC 110 is duplicated, and the room entrance qualification database 150 is duplicated. Also in a case in which such multiplexing is performed, the existence confirmation function described above can be implemented.

As illustrated in FIG. 8, when multiplexing is performed, the data illustrated in FIG. 8 can be stored as follows. That is, the data can be stored as P₁¹, P₁², P₁³, a separator, P₂¹, P₂², P₂³, P₂⁴, a separator, P₃¹, P₃², a separator, P₄¹, P₄², and an end symbol. Thereafter, when the data is encrypted and distributed similarly to the above description in “existence confirmation function”, each TRM can obtain the data.

The communication process M for mutual authentication of the computer device 100 in which each TRM is mounted does not operate so long as the other computer device 100 having the same function and higher priority than that of the former computer device 100 operates. For example, T₁² does not operate when T₁¹ operates, and T₁³ does not operate when any of T₁¹ and T₁² operates.

On the other hand, when the other computer device 100 having higher priority than the former computer device 100 does not operate, the former computer device 100 sends a message to all spares thereof and all the next numbers thereof. For example, T₁¹ sends a message to T₁² and T₁³, and to T₂¹, T₂², T₂³, and T₂⁴. The communication process M for mutual authentication of the TRM to which the message is transmitted verifies whether the communication process M needs to operate based on the transmitted information.

When the application managed by each TRM is tampered with or the operation thereof is stopped, each TRM notifies the spares thereof that the TRM is stopped. The TRM also notifies the next numbers thereof to be replaced with each other. Thereafter, the TRM restarts its own machine. After the restarting, the TRM takes over a work, if possible.

When some of the numbers previous to each TRM are stopped, or some of its own numbers do not operate, the TRM turns on a yellow warning lamp to warn the user. When each TRM confirms that all the numbers previous to the TRM are stopped, or the message from the number previous to the TRM does not arrive within a certain period of time, the TRM turns on a red warning lamp to warn the user.

In this way, the existence confirmation function can be implemented even when the computer device 100 is multiplexed.

Distribution and Integration

The components of the devices illustrated in the drawings are not physically configured as illustrated in some cases. That is, specific forms of distribution and integration of the devices are not limited to those illustrated in the drawings. All or part thereof may be functionally or physically distributed/integrated in arbitrary units depending on various loads or usage states.

An adverse effect caused by cracking can be prevented from being spread over various parts of the system.

All examples and conditional language recited herein are intended for pedagogical purposes of aiding the reader in understanding the invention and the concepts contributed by the inventors to further the art, and are not to be construed as limitations to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. A security system comprising:
a first device that includes a first processor and a first target processor; and
a second device that includes a second processor and a second target processor, wherein
the first processor executes a first process including:
first protecting a first program as a monitoring target among programs operating on the first target processor;
first decrypting encrypted data obtained by encrypting output data from the first program; and
first encrypting the decrypted output data and causing the encrypted data of the output data to be transmitted to the second device,
the second processor executes a second process including:
second protecting a second program as a monitoring target among programs operating on the second target processor;
second decrypting the transmitted encrypted data of the output data; and
second encrypting the decrypted output data and outputting the encrypted data of the output data to the second program.

2. The security system according to claim 1, wherein
the first encrypting includes encrypting output data to which tampering verification information of the output data decrypted at the first decrypting is added,
the second decrypting includes decrypting the transmitted encrypted data of the output data and verifying whether the output data is tampered with, and
when it is verified that the output data is not tampered with, the second encrypting includes encrypting the output data decrypted at the second decrypting.

3. The security system according to claim 1, wherein
the first processor has a first structure in which information stored inside is not referred to from the outside, the first processor being independent of the first target processor and a first memory included in the first device, and the second processor has a second structure in which information stored inside is not referred to from the outside, the second processor being independent of the second target processor and a second memory included in the second device.

4. The security system according to claim 3, wherein
the first device and the second device perform communication between the first processor and the second processor at predetermined intervals,
the first decrypting or the first encrypting includes allowing to perform processing when communication is not interrupted between the first processor and the second processor, and
the second decrypting or the second encrypting includes allowing to perform processing when communication is not interrupted between the first processor and the second processor.

5. The security system according to claim 3, wherein the first device or the second device includes a first display connected to the first processor or the second processor.

6. The security system according to claim 5, wherein
the second device further includes a second display connected to the second target processor, and
when the output data decrypted at the second decrypting is an image, the second processor embeds a mark in the image by causing frequency of embedding of the mark in the image displayed on the second display to be random between frames of the image, and controls display content of the second display in synchronization with a timing at which the mark is embedded in the image.

7. A communication method between a first device and a second device, the communication method comprising:
first protecting, by a first processor of the first device, a first program as a monitoring target among programs operating on a first target processor of the first device,
first decrypting, by the first processor, encrypted data obtained by encrypting output data from the first program,
first encrypting, by the first processor, the decrypted output data, and
first transmitting the encrypted data of the output data to the second device; and
second protecting, by a second processor of the second device, a second program as a monitoring target among programs operating on a second target processor of the second device,
second decrypting, by the second processor, the transmitted encrypted data of the output data,
second encrypting, by the second processor, the decrypted output data, and
second outputting the encrypted data of the output data to the second program.
